(19) United States
(12) Patent Application Publication
(10) Pub. No.: US 2006/0054284 A1
(43) Pub. Date: Mar. 16, 2006

(54) Device with flexible roller shutter

(75) Inventor: Benoit Coenraets, Brussels (BE)

Correspondence Address: BROWDY AND NEIMARK, P.L.L.C.;624 NINTH STREET, NW, SUITE 300, WASHINGTON, DC, 20001-5303, US

(73) Assignee: Dyanco International S A, Brussels (BE)

(21) Appl. No.: 10/468,129

(22) PCT Filed: Feb. 15, 2002
(86) PCT No.: PCT/BE02/00018

§ 371 Date: Sep. 14, 2005

(30) Foreign Application Priority Data
Feb. 16, 2001 (EP) 01870029.4

(51) Int. Cl. E05F 15/20

(52) U.S. Cl. 160/8

(57) ABSTRACT

This invention concerns a shutter system comprising, firstly, drive systems allowing the movement of the shutter (1) along a path between a closed and an open position, said shutter (1) being intended to close an opening (3) or other aperture and, secondly, detection systems (16) allowing determination of deflection of the shutter (1) from its path, for example due to the presence of an obstruction (13) below the shutter (1), during its movement into its closed or open position, the detection systems (16) combining with the drive systems in such a way as to permit stopping or opening of the shutter (1), each of the side edges of the shutter (1) running in a guide track (9). This system is characterised by the fact that the detection systems (16) are fitted in such a way as to be able to combine them with the guide track (9) in order to detect whether the shutter (1) is deflected from its path in the vicinity of the guide track (9).

This invention concerns a flexible shutter system combined with drive systems in such a way as to permit the shutter to move along a specific path between a closed and an open position. The said shutter is intended to close an opening or other aperture.

One of the essential objectives of this invention is the provision of a system of the aforementioned type which provides maximum safety when the shutter is moving towards its closed position and its path is obstructed, or if movement of the shutter is prevented for another reason during closure or opening.

For this purpose, inventive detection systems are provided which allow deflection of the shutter from its path to be determined, e.g. due to the presence of an obstruction below the shutter when it moves towards its closed or open position. The detection systems combine with the drive systems to stop or open the shutter.

In an advantageous embodiment of the inventive system, the aforementioned drive systems include a drum which may be rotated about its centre line, the aforementioned detection systems being fitted at the side of the drum at a certain distance from it so that if the shutter undergoes specific deflection from its path at the level of the drum, the detection systems will act upon the drive systems, stopping movement of the shutter towards its closed position.

In a particularly advantageous embodiment of the inventive system, a stiffened area is provided on the shutter, extending in the direction of movement of the latter.

Other details and particular features of the invention emerge from the description provided below, in non-exhaustive examples of several embodiments with references to the drawings appended hereto.

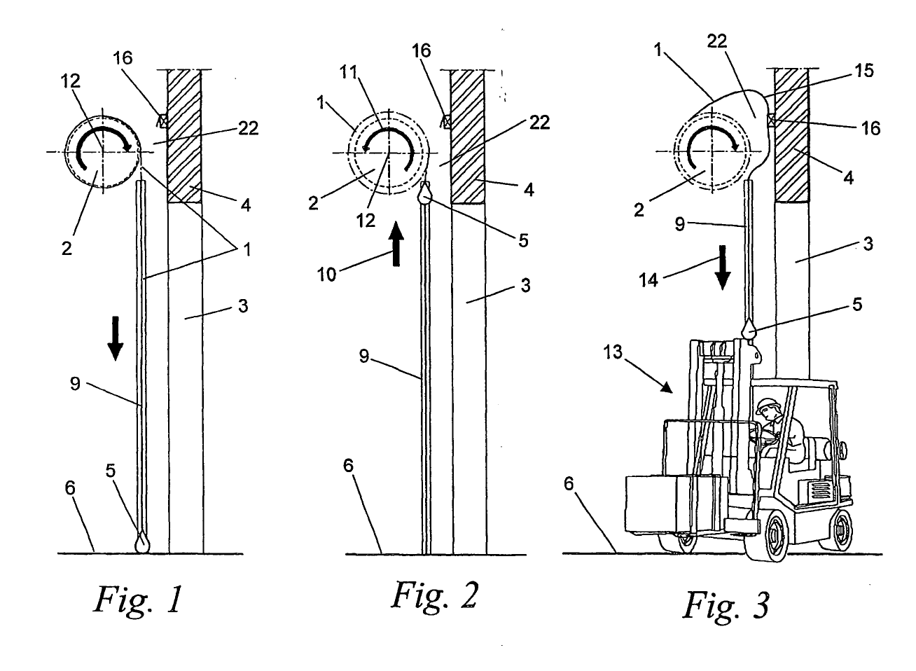

FIG. 1 is a diagrammatic vertical section through a first embodiment of the inventive system with the shutter in its closed position.

FIG. 2 is a view analogous to that in FIG. 1, with the shutter in its open position.

FIG. 3 is a view analogous to that in FIGS. 1 and 2 while the shutter is moving into its closed position and an obstruction is present in its path.

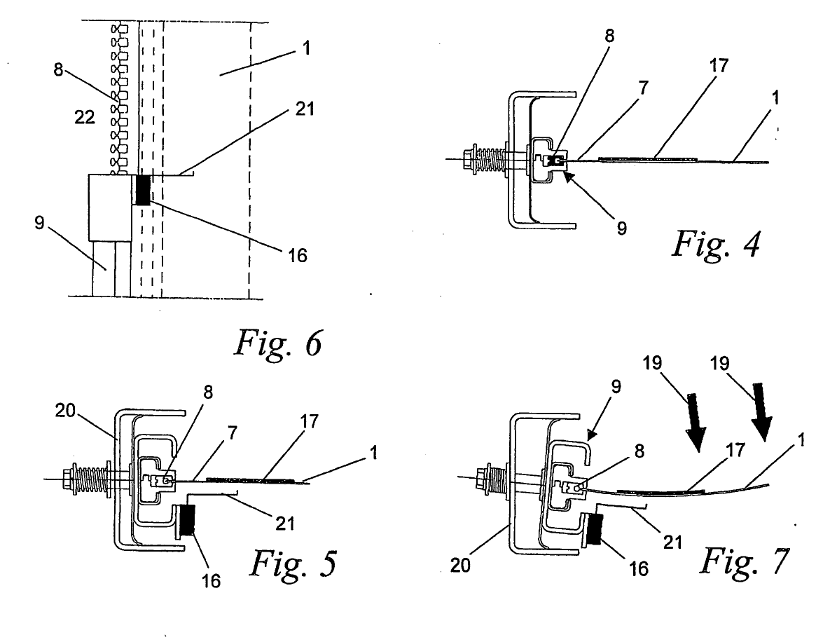

FIG. 4 is a partial lateral section through a shutter of which the side edges are held in guide tracks, on a larger scale.

FIG. 5 is a view, analogous to that in FIG. 4, of a second embodiment of the invention in which a switch is mounted on the guide track.

FIG. 6 is a front elevation of part of a shutter in accordance with the second embodiment of the invention, as shown in FIG. 5.

FIG. 7 is a view analogous to that in FIG. 5, of the second embodiment of the invention in which a transverse force is exercised on the plane of the shutter.

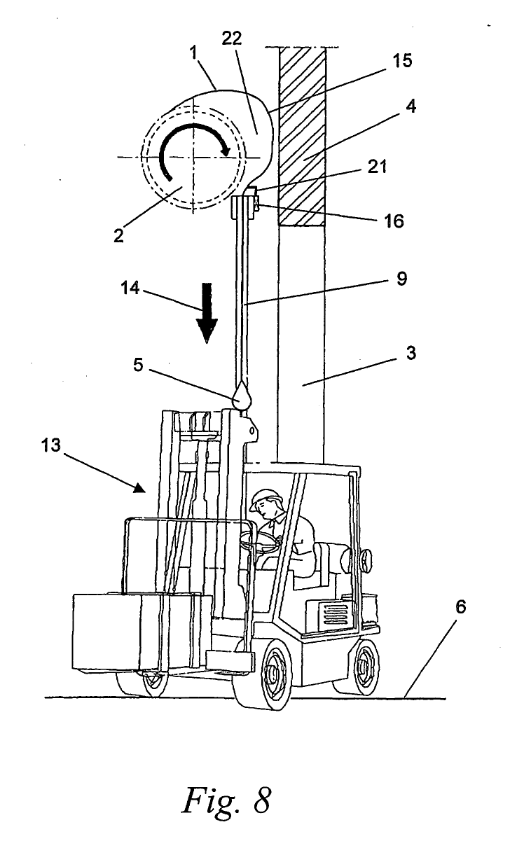

FIG. 8 is a diagrammatic vertical section through the second embodiment of the inventive system while the shutter is moving into its closed position and an obstruction is present in its path.

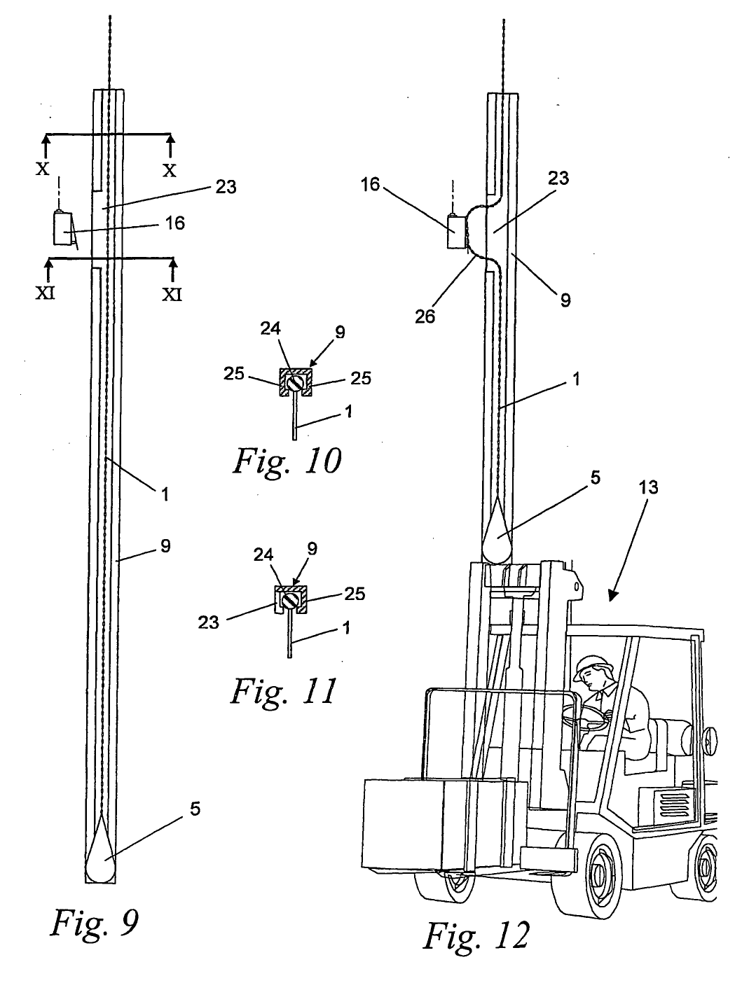

FIG. 9 is a diagrammatic vertical section through a third embodiment of the inventive system with the shutter in its closed position.

FIG. 10 is a horizontal section through the guide track along the line X-X in FIG. 9.

FIG. 11 is a horizontal section through the guide track along the line XI-XI in FIG. 9.

FIG. 12 is a view analogous to that in FIG. 9 while the shutter is moving into its closed position and an obstruction is present in its path.

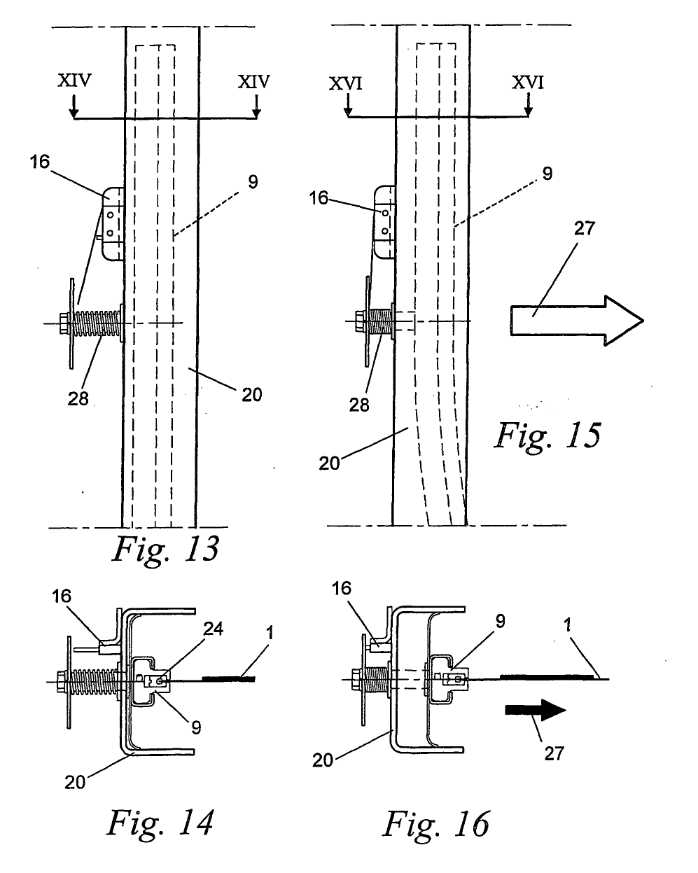

FIG. 13 is a diagrammatic horizontal section through part of a guide track in a fourth embodiment of the inventive system.

FIG. 14 is a horizontal section through the guide track along the line XIV-XIV in FIG. 13.

FIG. 15 is a view analogous to that in FIG. 13 when the shutter is deflected from its normal path.

FIG. 16 is a horizontal section through the guide track along line XVI-XVI in FIG. 15.

The same reference numbers refer to the same or analogous components in the various drawings.

In general, this invention concerns a shutter system 1 combined with drive systems such as a drum 2 of which the centre line is connected to the shaft of a motor (not shown). The shutter 1, which can move between a closed position and an open position, is intended to close an opening 3 in a wall 4 or any aperture.

In FIG. 1, the system is shown in its closed position with the lower edge 5 of the shutter 1 against the floor 6.

For the purposes of this invention, the word “shutter” should be understood as any component at least partially pliant, flexible, rigid or semi-rigid, such as a tarpaulin, a strip of plastic material, an assembly of articulated lamellae, a grille, etc. More specifically, it involves a shutter which may be folded or wound around a spindle at right angles to its direction of movement between its open and closed positions.

However, it should be noted that pronounced preference is given to pliant shutters formed by a tarpaulin. The drawings thus concern a shutter made up of a tarpaulin 1 of which the side edges 7 have, for example, a bead or a series of blocks 8, as shown in FIG. 6.

The shutter 1 is guided by its side edges 7 in guide tracks 9 extending approximately vertically on either side of the opening 3. When the shutter 1 opens, as shown in FIG. 2, its side edges 7 are moved along the guide tracks 9 in the direction indicated by the arrow 10 as a consequence of the shutter 1 being wound on the drum 2, which rotates around its centre line 12 in the direction indicated by the arrow 11. The guide tracks 9 are fixed to the wall 4 by systems not shown.

The shutter 1 is moved along a specific path during normal opening and closure. In a standard procedure, during normal operation of the shutter system, within the meaning of this description, this path corresponds to that followed by the shutter 1 during its movement between its closed position, as shown in FIG. 1, and its open position, as shown in FIG. 2.

Should any interference with normal operation of the shutter take place during movement of the latter in the direction indicated by the arrow 14 into its closed position, e.g. by an obstruction 13 located below the shutter 1 which consequently prevents movement of said shutter 1, part of the shutter 1 will be deflected from its normal path, by forming a bulge or gatherings located outside its path.

This bulge makes contact with detection systems, such as a switch 16, which acts upon the drive systems of the shutter 1 in such a way as to interrupt its descent.

In the embodiment shown in FIGS. 1 to 8, the guide tracks 9 extend along part of the path of the shutter 1 to a certain distance from the drive systems so that the shutter 1 is not guided over this distance. A gap 22 is thus formed between the upper end of the guide tracks 9 and the drive systems in which the shutter 1 is not guided laterally and into which the shutter 1 may be deflected if its movement is retarded, e.g. by the presence of an obstruction below the shutter 1.

As shown in FIG. 3, if an obstruction 13, such as a fork-lift truck, is fouled by the lower edge 5 of the shutter 1, the latter will form a bulge 15 above the guide tracks 9. This is caused by the fact that the drive systems will not stop immediately when the lower edge 5 of the shutter 1 encounters the obstruction 13. In particular, the drum 2 will continue to unroll the shutter 1 of which the movement of the lower edge 5 is prevented by the presence of the obstruction 13 in the path of the shutter 1.

Inventive detection systems are provided which allow determination of whether the shutter 1 is being deflected from its normal path.

It is advantageous for these detection systems to be fitted so that deflection of the shutter 1 from its path can be detected outside the guide track 9.

As shown in FIGS. 1 to 3, the detection systems include a switch 16 mounted to the side of the drum 2 at a certain distance from the latter and fitted against the wall 4 so that if the shutter 1 undergoes specific deflection from its path in the gap 22 at the level of the drum 2 due to the presence of an obstruction 13 below the shutter 1, the latter will encounter and operate the switch 16 by forming a bulge 15. The switch 16 combines with the drive systems to cause movement of the shutter 1 into its closed position to be interrupted. In order to remedy the interference caused by the obstruction 13 immediately, shutter 1 is preferably returned to its open position automatically by the drive systems .

In some cases, use of a highly pliant shutter 1 to obtain a very light shutter system which can open and close rapidly is indispensable. In this case, instead of forming a bulge 15, there is a risk that the shutters will gather if the lower edge 5 fouls an obstruction 13 when moving into its closed position.

In order to ensure that the switch 16 will be operated by the shutter 1 when the latter is deflected from its path, it is advantageous to provide a flexible stiffened area 17 on the shutter 1, as shown in diagrammatic form in FIG. 4. Said stiffened area 17 preferably extends into the vicinity of each of the side edges 7 of the shutter 1.

The stiffened area 17 may consist of a continuous plastic or metallic strip affixed to the shutter 1.

In a specific embodiment of the invention, the stiffened area 17 is formed by a series of rigid elements which are mounted alongside each other on one surface of the shutter 1. Said rigid elements are mounted on the surface of the shutter 1 facing the switch 16. Such a series of rigid elements ensures that the shutter will not gather and render it flexible in only one direction, so that a bulge 15 of a specific shape will be formed which will encounter the switch 16 if there is an obstruction below the shutter 1.

A different embodiment of the inventive shutter system is shown in FIGS. 5 to 8. In this embodiment, the detection systems include a switch 16 which is mounted on the guide track 9. The switch 16 is mounted in the vicinity of the path of the shutter I which is located outside the guide track 9, i.e. in the aforementioned gap 22 located between the drum 2 and the free upper end of the guide tracks 9, more specifically in the vicinity of said free end.

In this way, the switch 16 can detect whether the shutter 1 is being deflected from the section of the path located above the guide track 9.

The fact that the detection systems are mounted on the guide track 9 prevents the shutter 1 from encountering the switch 16 if a force is exercised on shutter 1 in a direction approximately transverse to the plane of the latter, e.g. by wind. In FIG. 7, the arrows 19 represent the forces exercised on the shutter 1 by wind. As illustrated, the shutter 1 is bent in the direction indicated by the arrow 19 by these forces and the guide track 9 is pivoted about its longitudinal axis from the position shown in FIG. 5. Due to the fact that the switch 16 is mounted on the guide track 9, it combines with the guide track 9, moving with it. However, the distance between the shutter 1 and the switch 16 remains approximately constant.

In this embodiment of the inventive shutter system, the guide track 9 is mounted on a bracket 20 which is fixed to the wall 4 in a flexible way and/or one which will allow it to pivot about an axis approximately parallel to the longitudinal axis of said guide track 9. Such a method of mounting guide tracks 9 has already been described in international patent application no. PCT/BE92/00017.

The switch 16 has an arm 21 which extends above the guide track 9, as clearly illustrated in FIGS. 6 and 8. In this way, if a bulge 15 forms above the guide track 9 due to the presence of an obstruction 13 below the shutter 1, it will encounter the arm 21 which is linked to the switch 16. Consequently, movement of the shutter 1 will be stopped and it will preferably be immediately wound on to the drum 2.

A third embodiment of the inventive shutter system is shown in FIGS. 9 to 12. In this embodiment, the guide tracks 9 form an essentially U-shaped channel, as shown in FIG. 10. The shutter 1 is thus guided in the guide tracks 9 by a block 24 which is located in the channel and which is provided on the side edges of the shutter 1.

In order to permit detection of whether an obstruction is located below the shutter 1 during closure of the latter, each guide track 9 contains a recess 23 over part of its length. Said recess 23 is, in particular, provided in one of the walls 25 of the guide track 9, as shown in FIGS. 9 and 11.

If closure of the shutter 1 is retarded by the presence of an obstruction, as shown in FIG. 12, shutter 1 may be deflected from its normal path by forming a bulge 26 extending across the recess 23.

A switch 16 is fitted opposite the recess 23 in order to detect such deflection of the shutter 1. In this way, the shutter 1, which has been deflected from its path, encounters the switch 16 which combines with the drive systems, thus causing the shutter 1 to stop or open.

In a variation of this inventive embodiment of the system, the guide track 9 has a cover at the height of the recess 23, such as a plate, which will become detached or move easily when the lower edge 5 of the shutter 1 encounters an obstruction and a bulge 26 is formed across said recess 23. The cover then encounters the switch 16 and sends a signal to the drive systems.

FIGS. 13 to 16 show a fourth embodiment of the inventive system, in which the guide tracks 9 are elastically mounted on a bracket 20 which is affixed to the wall. In this way, the guide tracks 9 can move relative to the bracket 20 if the shutter 1 gathers or if a force is applied to the plane of the shutter. The shutter 1 gathers, for example, if it is moving along the guide tracks 9 into its closed position and the lower edge 5 of the shutter 1 fouls an obstruction.

Due to the gathering of the shutter 1, its side edges 7 move towards each other and the shutter 1 is deflected from its normal path, moving the guide tracks 9 relative to the bracket 20 in the direction indicated by the arrow 27 in FIG. 16.

Such movement of the guide tracks 9 relative to the path is detected by the detection systems, particularly by a switch 16 mounted on the bracket 20 and thus linked to the guide tracks 9.

The guide tracks 9 are linked to a spring 28 forcing the former towards the bracket 20, to ensure that the shutter 1 is flat.

It is self-evident that the invention is not restricted to the various embodiments described above and that other variations may be envisaged without departing from the scope of this invention, particularly in respect of the position of the switch. It is possible to install several switches, for example on the two side edges of the shutter 1.

In other respects, the detection systems may include any means which allow the presence of a bulge to be detected, such as, for example, optical detection systems, particularly an electronic eye.

In addition, the stiffened area may be affixed to the shutter continuously, or intermittently by discrete fixings. For example, the stiffened area may consist of a reinforced side edge of the shutter 1.

1. Shutter system consisting of, firstly, drive systems permitting movement of the shutter (1) along a path between a closed and an open position, intended to close an opening (3) or other aperture and, secondly, detection systems (16) allow determination of whether the shutter (1) is being deflected from its path, for example, by the presence of an obstruction (13) below the shutter (1) during its movement into its closed position or open position, said detection systems (16) being linked to the drive systems in such a way as to stop or open the shutter (1), each of the side edges of the shutter (1) running in a guide track (9), characterised by the fact that the detection systems (16) are fitted in a way permitting their combination with the guide track (9) in order to detect whether the shutter (1) is being deflected from its path in the vicinity of the guide track (9).

2. System in accordance with claim 1, characterised by the fact that the detection systems include at least one switch (16) fitted in such a way as to permit the shutter (1) undergoing deflection from its path to operate the switch (16) and interrupt movement of the shutter (1) towards its closed or open position.

3. System in accordance with claims 1 or 2, characterised by the fact that the part of the path alongside the opening (3) or other aperture is demarcated by a guide track (9) extending downwards from the drive systems (2).

4. System in accordance with claim 3, characterised by the fact that the aforementioned detection systems (16) are fitted in such a way as to permit deflection of the shutter (1) from its path at a point located outside the guide track (9).

5. System in accordance with claim 3, characterised by the fact that the detection systems (16) are mounted on the guide track (9) in the vicinity of that part of the path located outside the guide track (9).

6. System in accordance with claim 5, characterised by the fact that the guide track (9) is elastically mounted on a bracket (20) in a flexible way and/or one which will allow it to pivot about an axis approximately parallel to the longitudinal axis of the guide track (9) so that if a force is applied to the plane of the shutter (1) when it is not fully open, the detection systems (16) will move with the guide track (9) to avoid being operated by the movement of the shutter (1) due to said force.

7. System in accordance with claim 3, characterised by the fact that the guide tracks (9) have a recess (23) which permits the shutter (1) to be deflected across said recess (23) when normal opening or closure of the shutter (1) is disturbed, e.g. due to the presence of an obstruction (13) below the shutter (1), the aforementioned detection systems (16) being fitted in a way to allow such deflection to be detected.

8. System in accordance with claim 7, characterised by the fact that the guide tracks (9) essentially take the form of U-shaped channel, the aforementioned recess (23) being provided in one of the walls (25) of the U.

9. System in accordance with claim 3, characterised by the fact that the guide tracks (9) are flexibly mounted on a bracket (20) so that if the shutter (1) is deflected from its path when running in the guide tracks (9), the latter are deflected from the bracket (20), the detection systems (16) being fitted in such a way as to permit detection of such movement.

10. System in accordance with claim 9, characterised by the fact that the guide tracks (9) linked to a spring (8) apply a force to the guide tracks (9) towards the bracket (20) in order to flatten the shutter (1).

11. System in accordance with claim 1 or claim 10, characterised in that the aforementioned drive systems include a drum (2) which can be rotated about its centre line (12), the aforementioned detection systems (16) being mounted to the side of the drum (2) and at a certain distance from it, so that if the shutter (1) undergoes specific deflection from its path at the level of the drum (2), the detection systems (16) combine with the drive systems by stopping movement of the shutter (1) into its closed position.

12. System in accordance with claim 11, characterised by the fact that the detection systems include at least one switch (16) mounted to the side of the drum (2) at a certain distance from it and fitted in such a way as to permit the shutter (1) undergoing deflection from its path at the level of the drum (2) to operate the switch (16) and interrupt the movement of the shutter (1) towards its closed position.

13. System in accordance with claim 1, characterised by the fact that a flexible stiffened area (17) is provided on the shutter (1), extending in the direction of movement of the shutter (1).

14. System in accordance with claim 1, characterised by the fact that a flexible stiffened area (17) extends into the vicinity of both the side edges (7) of the shutter (1).

15. System in accordance with one of either claims 13 or 14, characterised by the fact that the stiffened area combines with the detection systems in order to detect deflection of the shutter (1) from its path.

16. Flexible shutter for use in a closure system and intended for the closure of an opening (3) or other aperture in which the shutter (1) is unwound from a drum (2) along a path during closure of the opening (3) or other aperture by moving in guide tracks (9) which are arranged along the opening (3) or other aperture, characterised by the fact that a flexible stiffened area (17) extends into the vicinity of at least one side edge (7) of the shutter (1) in order to be able to bend if the shutter (1) is deflected from its path and to be able to combine with detection systems (16) detecting the curvature (26) of the stiffened area (17).
